(19) United States
(12) Patent Application Publication
(10) Pub. No.: US 2023/0259808 A1
(43) Pub. Date: Aug. 17, 2023

(54) ACTIVE LEARNING FOR EVENT EXTRACTION FROM HETEROGENEOUS DATA SOURCES

(71) Applicant: International Business Machines Corporation, Armonk, NY (US)

(72) Inventors: Bharath Dandala, White Plains, NY (US); Ananya Aniruddha Poddar, White Plains, NY (US); Diwakar Mahajan, New York, NY (US); Ching-Huei Tsou, Briarcliff Manor, NY (US); Parthasarathy Suryanarayanan, Croton On Hudson, NY (US); Divya Ranganathan Pathak, Scarsdale, NY (US)

(21) Appl. No.: 17/651,381

(22) Filed: Feb. 16, 2022

(51) Int. Cl. G06N 20/00; G06K 9/62

(52) U.S. Cl. CPC G06N 20/00; G06K 9/6265; G06K 9/6256

(57) ABSTRACT

Systems, devices, computer-implemented methods, and/or computer program products that can facilitate event extraction from heterogeneous data sources using an active learning framework are provided. In one example, a system can comprise a processor that executes computer executable components stored in memory. The computer executable components can comprise a training component and a learning-based sample component. The training component can train one or more models to recognize one or more events from data input into the system, extract one or more triggers from the data input into the system, extract one or more arguments from the data input into the system, or extract one or more roles from the data input into the system. The learning-based sample component can determine a sampled dataset by applying a learning-based sample to the one or more models.

### BACKGROUND

One or more embodiments herein relate to computing devices, and more specifically, to systems, devices, computer-implemented methods, and/or computer program products that can facilitate event extraction from heterogeneous data sources using an active learning framework.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that can facilitate event extraction from heterogeneous data sources are described.

According to an embodiment, a system can comprise a memory that stores computer executable components and a processor that executes the computer executable components stored in the memory. The computer executable components can comprise a training component and a learning-based sample component. The training component can train one or more models to recognize one or more events from data input into the system, extract one or more triggers from the data input into the system, extract one or more arguments from the data input into the system, or extract one or more roles from the data input into the system. The learning-based sample component can determine a sampled dataset by applying a learning-based sample to the one or more models. According to another embodiment, a computer-implemented method or a computer program product can facilitate event extraction similar to the aforementioned system.

### DESCRIPTION OF THE DRAWINGS

FIG. 1 illustrates a block diagram of an example, non-limiting system that can facilitate event extraction from heterogeneous data sources in accordance with one or more embodiments described herein.

FIG. 2 illustrates a block diagram of an example, non-limiting system that can facilitate event extraction from heterogeneous data sources in accordance with one or more embodiments described herein.

FIG. 3 illustrates an example, non-limiting high-level conceptual overview of event extractions from heterogeneous data sources in accordance with one or more embodiments described herein.

FIG. 4 illustrates a block diagram of an example, non-limiting system that can facilitate event extraction from heterogeneous data sources using a plurality of subtasks in accordance with one or more embodiments described herein.

FIG. 5 illustrates a flow diagram of an example, non-limiting computer-implemented method that can facilitate event extraction from heterogeneous data sources in accordance with one or more embodiments described herein.

FIG. 6 illustrates a block diagram of an example, non-limiting operating environment in which one or more embodiments described herein can be facilitated.

FIG. 7 illustrates a block diagram of an example, non-limiting cloud computing environment in accordance with one or more embodiments of the subject disclosure.

FIG. 8 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

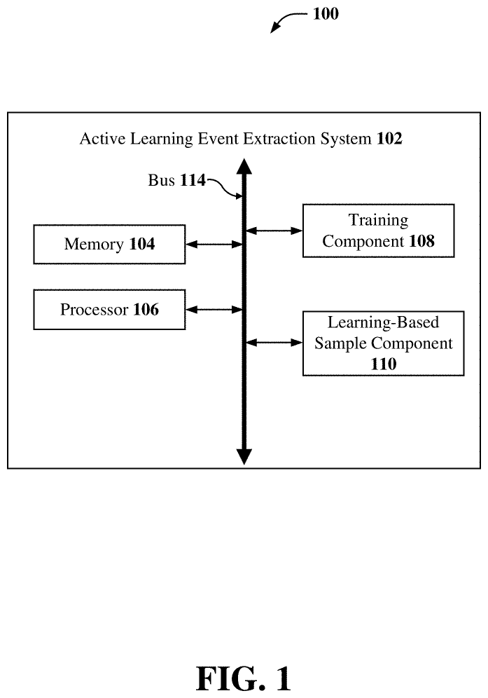

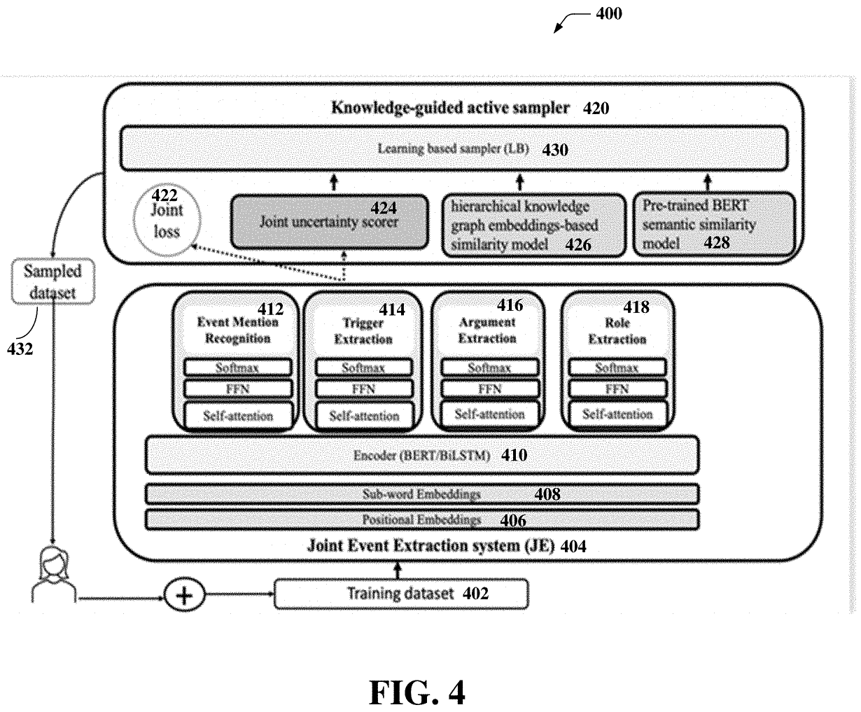

FIG. 1 illustrates a block diagram of an example, non-limiting system 100 that can facilitate event extraction from heterogeneous data sources, in accordance with one or more embodiments described herein. FIG. 4 illustrates a block diagram of an example, non-limiting system 400 that can facilitate event extraction from heterogeneous data sources using a plurality of subtasks in accordance with one or more embodiments described herein. In some embodiments, system 100 can comprise an active learning events extraction system 102. The active learning events extraction system 102 can comprise memory 104, processor 106, training component 108, and/or learning-based sample component 110. In various embodiments, one or more of the memory 104, processor 106, training component 108, and/or learning-based sample component 110 can be electrically, operatively and/or communicatively coupled to one another.

Memory 104 can store one or more computer-executable components and can be operably coupled to processor 106. Processor 106 can execute the one or more computer-executable components. In various embodiments, the one or more computer-executable components can be stored in memory 104 or one or more other storage locations (not shown) accessible to processor 106. As shown in FIG. 1, the one or more computer-executable components can include training component 108, and/or learning-based sample component 110.

Training component 108 can train the one or more models to recognize one or more events from data input into the system, extract one or more triggers from the data input into the system, extract one or more arguments from the data input into the system, or extract one or more roles from the data input into the system. For example, in one embodiment, the training component 108 can train concurrently models for event mention recognition, trigger extraction, argument extraction and/or role extraction using an optimization algorithm with training data to learn from. The training component 108 can comprise optimizers such as Adam to train these models. In some embodiments, these models can comprise a shared encoded layer followed by their individual self-attention layers and a feed forward network (FFN). The shared encoded layer can be a bidirectional long short-term memory (LSTM) or a transformer-based encoder.

Learning-based sample component 110 can determine a sampled dataset by applying a learning-based sample to the one or more models. For example, in one embodiment, learning-based sample component 110 can select events by applying learning algorithms that can produce a sampled dataset, or a smart sample. The sampled dataset can be used to build datasets that cover larger variations of events. In various embodiments, the learning-based sample component 110 can jointly select the events that maximize the uncertainty scores that can be obtained from the one or more models of a plurality of subtasks, a hierarchical knowledge graph embeddings-based similarity model, semantic similarity-based uncertainty model and/or syntactic similarity-based uncertainty model. The plurality of subtasks can include, but are not limited to, event mention recognition, trigger extraction, argument extraction and/or role extraction using an optimization algorithm.

In some embodiments, the learning-based sample component 110 can perform uncertainty sampling that can be a strategy for identifying unlabeled items that are near a decision boundary in a current machine learning model. For example, in various embodiments, at each iteration of new labeled datasets, the learning-based sample component 110 can concurrently minimize joint loss from datasets from all of the previous iterations and from the current input dataset. In some embodiments, the learning-based sample component 110 can measure the uncertainty score between existing events in a training data and a present event.

Moving to FIG. 4, in some embodiments, a training dataset 402 can be inputted into a joint event extraction system 404. The joint event extraction system 404 can include a shared positional embeddings layer 406 that can be input into a shared sub-word embeddings layer 408. In some embodiments, the training component 108 can train concurrently the models for event mention recognition 412, trigger extraction 414, argument extraction 416, or role extraction 418. These models can include a shared encoded layer 410 followed by individual self-attention layers, an individual feed forward network or individual softmax layers. The softmax layer can include a softmax function to obtain probabilities of the events being misclassified for training samples.

In some embodiments, the joint event extraction system 404 can output into a knowledge-guided active sampler 420. The knowledge-guided active sampler 420 can comprise a joint loss 422, which can be computed from the outputs from the feed forward networks. The joint loss component 202 can generate the joint loss 422. The active sampler 420 can also comprise a joint uncertainty scorer 424, which can output probabilities of misclassifications, or uncertainty scores, for each model given an event. The uncertainty scores component 204 can generate the uncertainty scores. The active sampler 420 can comprise a knowledge graph-based hierarchical uncertainty scorer 426 or a semantic or syntactic uncertainty scorer 428, where uncertainty values of a given unlabeled event can be computed. To calculate the uncertainty value, “1−similarity” between existing events in training data and current event can be measured. The knowledge-guided active sampler 420 can comprise a learning-based sampler 430, which can jointly select events that jointly maximize the uncertainty scores obtained from models of individual subtasks. The learning-based sample component 110 can determine the sampled dataset based on the jointly selected events.

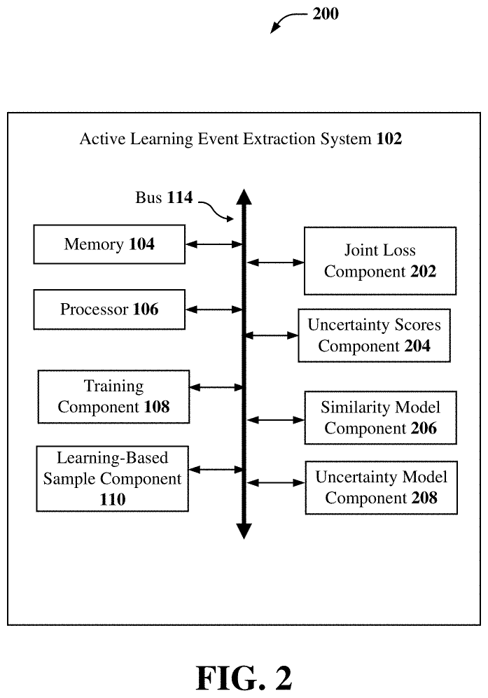

FIG. 2 illustrates a block diagram of an example, non-limiting system 200 that can facilitate event extraction from heterogeneous data sources in accordance with one or more embodiments described herein. In some embodiments, system 200 can comprise active learning event extraction system 102. The active learning event extraction system 102 can comprise a joint loss component 202, an uncertainty scores component 204, similarity model component 206 and/or an uncertainty model component 208. In various embodiments, joint loss component 202, uncertainty scores component 204, similarity model component 206 and/or uncertainty model component 208 can be electrically, operatively and/or communicatively coupled to one another. Repetitive description of like elements and/or processes employed in respective embodiments is omitted for sake of brevity.

Joint loss component 202 can generate a joint loss of one or more models based on one or more outputs of the one or more models. The joint loss component 202 can comprise optimization algorithms. For example, in various embodiments, the algorithms can compute the joint loss from one or more outputs of feed forward networks (FFNs) that are within the one or more models. There can be one joint loss across the one or more models. In various embodiments, a loss can be a penalty score indicating how bad the one or more models' prediction was on a single example. The one or more models can be optimized jointly. The joint loss can be minimized to improve the performance on the one or more models jointly. The objective of machine learning models can be to find a function with weights and loss that minimize the average loss across all training examples, or the average difference between the one or more models' predictions and the actual ground truth values. In various embodiments, multi-task learning (MTL) is a machine learning approach in which the one or more models can be solved at the same time, while exploiting commonalities and differences across multiple underlying tasks.

Uncertainty scores component 204 can determine one or more uncertainty scores based on the joint loss. The one or more uncertainty scores can represent the probabilities of misclassifications of unlabeled data from the one or more models. In some embodiments, when given an input event, the one or more models can take losses as inputs from individual subtask layers and outputs probabilities of misclassifications, or uncertainty scores, for each event. The uncertainty scores component 204 can contain a multi-layered feed forward neural network that can combine the probabilities to assign an uncertainty score for each event.

Similarity model component 206 can generate a hierarchical knowledge graph embeddings-based similarity model based on the one or more outputs of the one or more models. In some embodiments, the similarity model component 206 can comprise network representation learning techniques that can be used on ontologies to generate hierarchical knowledge embeddings. For example, in various embodiments, the similarity model component 206 can input an event structure of each labeled event that can be mapped into knowledge graph embeddings space followed by encoding using a graph convolutional network to obtain a single representation. In some embodiments, when given an unlabeled event, the similarity model component 206 can automatically extract event structure, obtain its encoded representation, or semantically similar events can be selected from existing labeled events.

Uncertainty model component 208 can generate at least one of a semantic similarity-based uncertainty model or syntactic similarity-based uncertainty model based on the one or more outputs of the one or more models. In various embodiments, the semantic similarity-based uncertainty model can be used to obtain a semantic similarity-based uncertainty score for an unlabeled event. The syntactic similarity-based uncertainty model can be used to obtain syntactic similarity-based uncertainty score for an unlabeled event. In various embodiments, when given an unlabeled event, a top semantically similar event or n-best syntactically similar events can be selected from a current labeled dataset. The uncertainty value for the given unlabeled event can be computed as Σₖ₌₁ⁿ(1−similarityₖ).

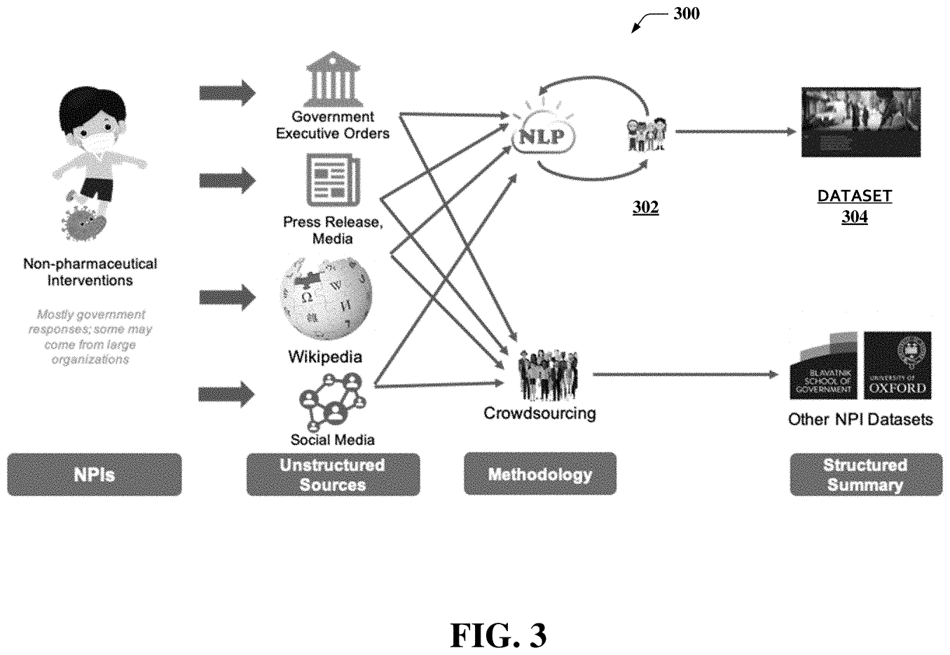

FIG. 3 illustrates an example, non-limiting high-level conceptual overview of event extractions from heterogeneous data sources. An event can be information in a document that needs to be identified. The events could be extracted in real-time but can also be extracted from text documents. For example, non-pharmaceutical interventions (NPIs) can be a type of event that comes mostly from government responses or large organizations. The United States Centers for Disease Control and Prevention (CDC) states that NPIs can denote “actions, apart from getting vaccinated and taking medicine, that people and communities can take to help slow the spread of illnesses like the flu”. Such actions can generally be implemented when vaccines or other pharmaceutical measures are not yet available. Example NPIs can include, but not be limited to, community actions (e.g., school closures, restrictions on mass gatherings, and/or other community actions), individual actions (e.g., self-quarantining, and/or other individual actions), environmental actions (e.g., public facility cleaning, public transport cleaning, and/or other environmental actions), and/or other NPI-related actions.

Public health policy makers can utilize such information to train machine learning models that predict the efficacy of implementing different NPI strategies. However, such NPI data is generally published as unlabeled data on a wide variety of heterogeneous data sources. FIG. 3 shows that such heterogeneous data sources can include, but not be limited to: government sources, press releases or news articles, curated knowledge graphs (e.g., curated knowledge graphs underlying the Wikipedia® articles published by Wikimedia Foundation, Inc., of San Francisco, Calif.), social media platforms, and/or other heterogeneous data sources comprising NPI-related information.

A number of data curation initiatives have emerged to create datasets that present NPI data in standardized or structured formats. While effective, these data curation initiatives generally use labor-intensive and/or time-consuming crowdsourcing methodologies to create those other NPI datasets shown by FIG. 3. Moreover, those other NPI datasets can present NPI data with varying degrees of coverage, data freshness, and/or granularity of details given the unprecedented volume of data available in the wide variety of heterogeneous data sources. Any combination of scarcity, sparsity, and/or staleness in training data can reduce the accuracy of machine learning models trained on such training data. Therefore, the varying degrees of coverage, data freshness, and/or granularity of details regarding NPI data presented by those other NPI datasets can inhibit the ability of machine learning models trained on such NPI data to predict the efficacy of implementing different NPI strategies.

As shown by FIG. 3, implementations of the present disclosure can involve a machine learning framework 302 that can facilitate event extractions from heterogeneous data sources. Embodiments of machine learning framework 302 can facilitate creating NPI datasets 304 (e.g., comprehensive dataset of pharmaceutical interventions) that present such NPI data in a defined format. That defined format can facilitate mitigating the data scarcity and/or sparsity issues discussed above with respect to the other NPI datasets. Moreover, embodiments of machine learning framework 302 can continuously extract events from the heterogeneous data sources to facilitate capturing incremental changes in such NPI data. Continuously extracting events can facilitate mitigating the data staleness issue discussed above with respect to the other NPI datasets. Through the defined format and/or such continuous extraction, embodiments of machine learning framework 302 can create NPI datasets that present robust and/or frequently updated NPI data to facilitate training machine learning models with improved predictive performance.

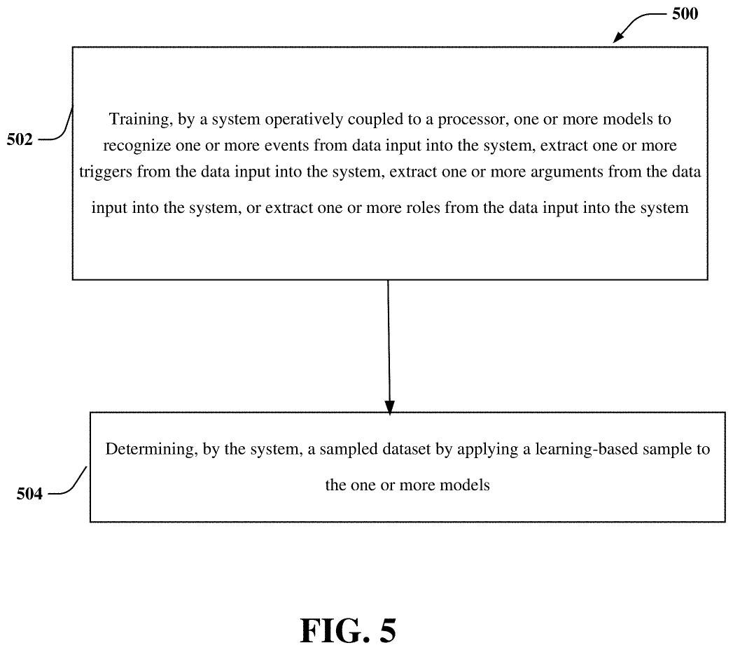

FIG. 5 illustrates a flow diagram of an example, non-limiting computer-implemented method 500 that can facilitate event extraction from heterogeneous data sources in accordance with one or more embodiments described herein. Repetitive description of like elements and/or processes employed in respective embodiments is omitted for sake of brevity.

At 502, computer-implemented method 500 can comprise training, by a system (e.g., via active learning events extraction system 102 and/or training component 108) operatively coupled to a processor (e.g., processor 106, a quantum processor, etc.), one or more models (e.g., a pre-trained language model (e.g., transformer based) fine-tuning, etc.) to recognize one or more events from data input into the system, extract one or more triggers from the data input into the system, extract one or more arguments from the data input into the system, or extract one or more roles from the data input into the system.

At 504, computer-implemented method 500 can comprise determining, by the system (e.g., via active learning events extraction system 102 and/or learning-based sample component 110), a sampled dataset by applying a learning-based sample to the one or more models.

In some embodiments, computer-implemented method 500 can comprise generating, by the system (e.g., via active learning events extraction system 102 and/or joint loss component 202), a joint loss of the one or more models based on one or more outputs of the one or more models.

In some embodiments, computer-implemented method 500 can comprise determining, by the system (e.g., via active learning events extraction system 102 and/or uncertainty scores component 204), one or more uncertainty scores based on the joint loss.

In some embodiments, computer-implemented method 500 can comprise selecting, by the system (e.g., via active learning events extraction system 102 and/or learning-based sample component 110), one or more events that jointly maximize the one or more uncertainty scores obtained from the one or more models.

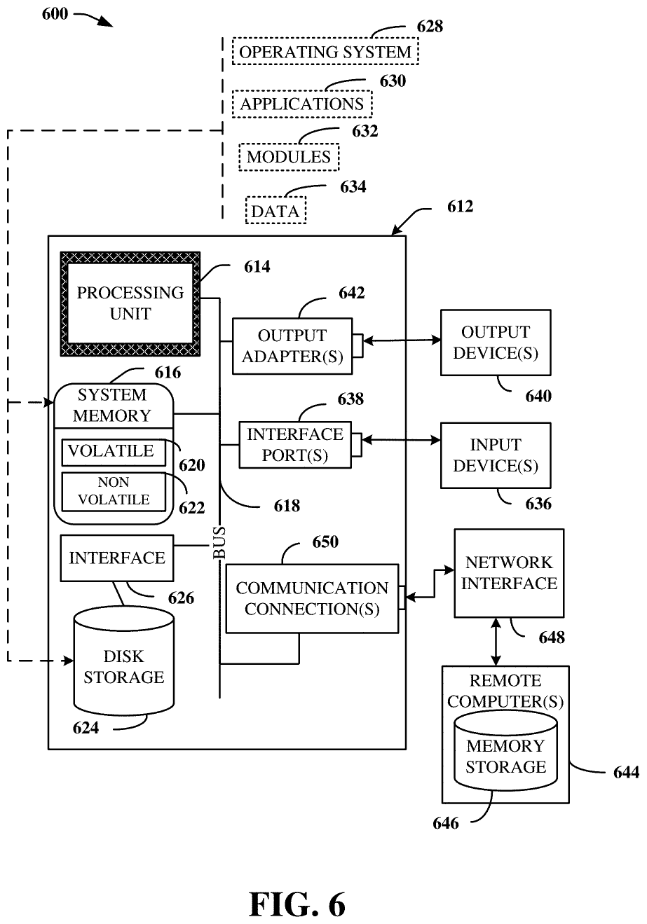

In order to provide a context for the various aspects of the disclosed subject matter, FIG. 6 as well as the following discussion are intended to provide a general description of a suitable environment in which the various aspects of the disclosed subject matter can be implemented. FIG. 6 illustrates a block diagram of an example, non-limiting operating environment in which one or more embodiments described herein can be facilitated. Repetitive description of like elements employed in other embodiments described herein is omitted for sake of brevity.

With reference to FIG. 6, a suitable operating environment 600 for implementing various aspects of this disclosure can also include a computer 612. The computer 612 can also include a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614. The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 616 can also include volatile memory 620 and nonvolatile memory 622. The basic input/output system (BIOS), containing the basic routines to transfer information between elements within the computer 612, such as during start-up, is stored in nonvolatile memory 622. Computer 612 can also include removable/non-removable, volatile/non-volatile computer storage media. FIG. 6 illustrates, for example, a disk storage 624. Disk storage 624 can also include, but is not limited to, devices like a magnetic disk drive, floppy disk drive, tape drive, Jaz drive, Zip drive, LS-100 drive, flash memory card, or memory stick. The disk storage 624 also can include storage media separately or in combination with other storage media. To facilitate connection of the disk storage 624 to the system bus 618, a removable or non-removable interface is typically used, such as interface 626. FIG. 6 also depicts software that acts as an intermediary between users and the basic computer resources described in the suitable operating environment 600. Such software can also include, for example, an operating system 628. Operating system 628, which can be stored on disk storage 624, acts to control and allocate resources of the computer 612.

System applications 630 take advantage of the management of resources by operating system 628 through program modules 632 and program data 634, e.g., stored either in system memory 616 or on disk storage 624. It is to be appreciated that this disclosure can be implemented with various operating systems or combinations of operating systems. A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port can be used to provide input to computer 612, and to output information from computer 612 to an output device 640. Output adapter 642 is provided to illustrate that there are some output devices 640 like monitors, speakers, and printers, among other output devices 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a computer, a server, a router, a network PC, a workstation, a microprocessor-based appliance, a peer device or other common network node and the like, and typically can also include many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 650 refers to the hardware/software employed to connect the network interface 1048 to the system bus 618. While communication connection 650 is shown for illustrative clarity inside computer 612, it can also be external to computer 612. The hardware/software for connection to the network interface 648 can also include, for exemplary purposes only, internal and external technologies such as, modems including regular telephone grade modems, cable modems and DSL modems, ISDN adapters, and Ethernet cards.

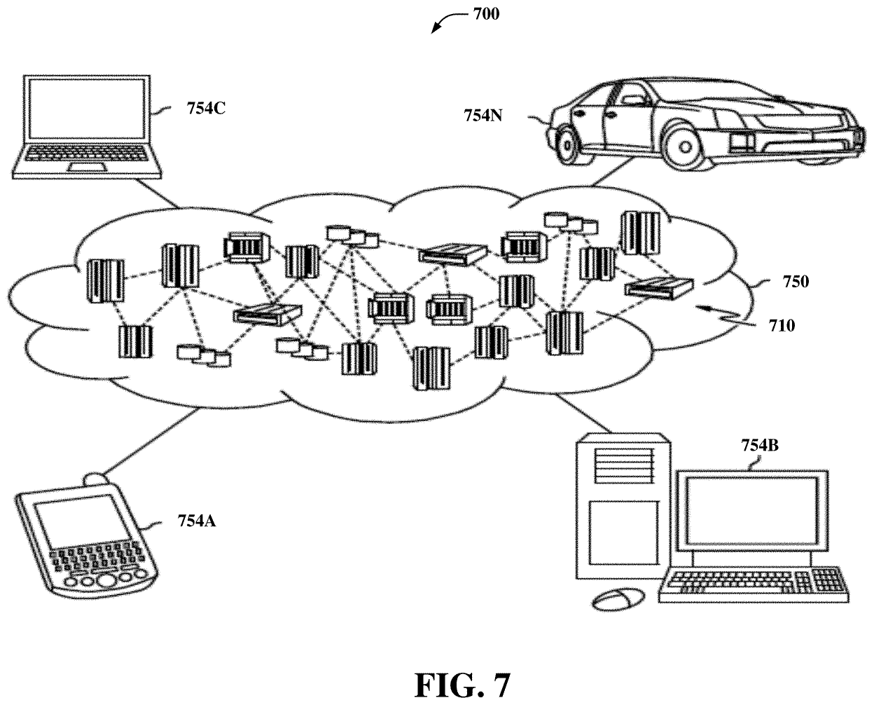

Referring now to FIG. 7, an illustrative cloud computing environment 750 is depicted. As shown, cloud computing environment 750 includes one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as Private, Community, Public, or Hybrid clouds as described hereinabove, or a combination thereof. This allows cloud computing environment 750 to offer infrastructure, platforms and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

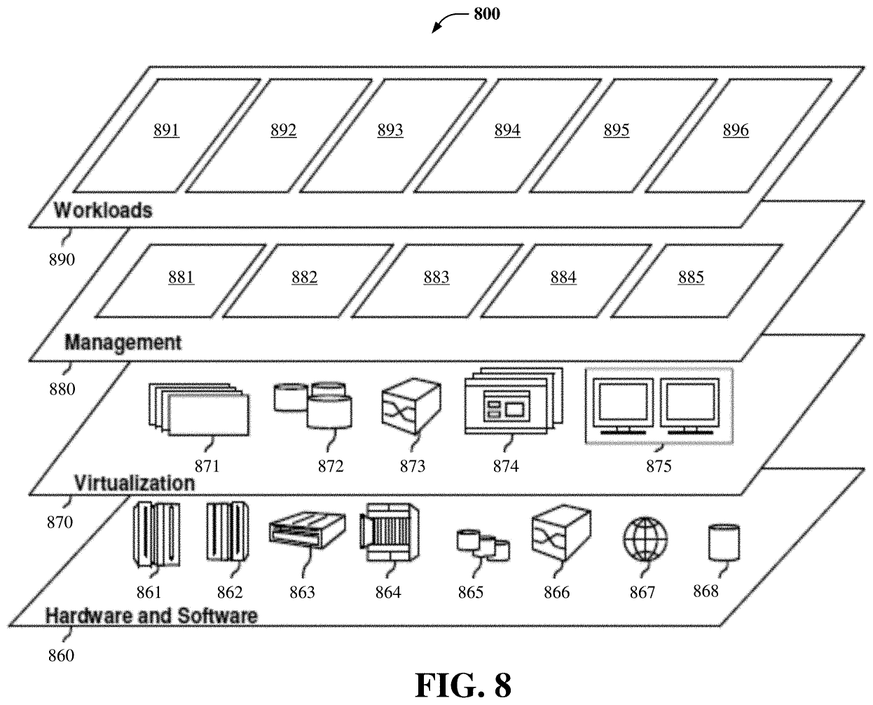

Referring now to FIG. 8, a set of functional abstraction layers provided by cloud computing environment 750 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 860 includes hardware and software components. Examples of hardware components include: mainframes 861; RISC (Reduced Instruction Set Computer) architecture-based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, management layer 880 may provide the functions described below. Resource provisioning 881 provides dynamic procurement of computing resources and other resources that are utilized to perform tasks within the cloud computing environment. Metering and Pricing 882 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Non-limiting examples of workloads and functions which may be provided from this layer include: mapping and navigation 891; software development and lifecycle management 892; virtual classroom education delivery 893; data analytics processing 894; transaction processing 895; and medication events summarization software 896.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for event extraction, comprising:
a memory that stores computer executable components; and
a processor that executes the computer executable components stored in the memory, wherein the computer executable components comprise:
a training component that trains one or more models to recognize one or more events from data input into the system, extract one or more triggers from the data input into the system, extract one or more arguments from the data input into the system, or extract one or more roles from the data input into the system; and
a learning-based sample component that determines a sampled dataset by applying a learning-based sample to the one or more models.

2. The system of claim 1, wherein the computer executable components further comprise:
a joint loss component that generates a joint loss of the one or more models based on one or more outputs of the one or more models; and
an uncertainty scores component that determines one or more uncertainty scores based on the joint loss.

3. The system of claim 2, wherein the learning-based sample component selects one or more events that jointly maximize the one or more uncertainty scores obtained from the one or more models.

4. The system of claim 3, wherein a plurality of subtasks comprises two or more of the following subtasks: event mention recognition, trigger extraction, argument extraction or role extraction, wherein the event mention recognition, trigger extraction, argument extraction or role extraction are the one or more models.

5. The system of claim 1, wherein the one or more uncertainty scores is measured between existing events in a training data and a present event.

6. The system of claim 1, wherein the training component trains the one or more models concurrently to extract the one or more triggers, the one or more arguments or the one or more roles.

7. The system of claim 1, wherein the training component comprises functions to obtain probabilities of the events being misclassified.

8. A computer-implemented method for event extraction comprising:
training, by a system operatively coupled to a processor, one or more models to recognize one or more events from data input into the system, extract one or more triggers from the data input into the system, extract one or more arguments from the data input into the system, or extract one or more roles from the data input into the system; and
determining, by the system, a sampled dataset by applying a learning-based sample to the one or more models.

9. The computer-implemented method of claim 8, further comprising:
generating, by the system, a joint loss of the one or more models based on one or more outputs of the one or more models; and
determining, by the system, one or more uncertainty scores based on the joint loss.

10. The computer-implemented method of claim 9, further comprising:
selecting, by the system, one or more events that jointly maximize the one or more uncertainty scores obtained from the one or more models.

11. The computer-implemented method of claim 10, wherein a plurality of subtasks comprises two or more of the following subtasks: event mention recognition, trigger extraction, argument extraction or role extraction, wherein the event mention recognition, trigger extraction, argument extraction or role extraction are the one or more models.

12. The computer-implemented method of claim 8, wherein the one or more uncertainty scores is measured between existing events in a training data and a present event.

13. The computer-implemented method of claim 8, wherein the training comprises training the one or more models concurrently to extract the one or more triggers, the one or more arguments or the one or more roles.

14. The computer-implemented method of claim 8, wherein the training obtains probabilities of the events being misclassified.

15. A computer program product facilitating a process to extract event data from heterogenous data sources, the computer program product comprising a computer readable storage medium having program instructions embodied therewith, the program instructions executable by a processor to cause the processor to:
train, by the processor, one or more models to recognize one or more events from data input into the system, extract one or more triggers from the data input into the system, extract one or more arguments from the data input into the system, or extract one or more roles from the data input into the system; and
determine, by the processor, a sampled dataset by applying a learning-based sample to the one or more models.

16. The computer program product of claim 15, wherein the program instructions are further executable by the processor to cause the processor to:
generate, by the processor, a joint loss of the one or more models based on one or more outputs of the one or more models; and
determine, by the processor, one or more uncertainty scores based on the joint loss.

17. The computer program product of claim 16, wherein the program instructions are further executable by the processor to cause the processor to:
select, by the processor, one or more events that jointly maximize the one or more uncertainty scores obtained from the one or more models.

18. The computer program product of claim 17, wherein a plurality of subtasks comprises two or more of the following subtasks: event mention recognition, trigger extraction, argument extraction or role extraction, wherein the event mention recognition, trigger extraction, argument extraction or role extraction are the one or more models.

19. The computer program product of claim 15, wherein the training comprises training the one or more models concurrently to extract the one or more triggers, the one or more arguments or the one or more roles.

20. The computer program product of claim 15, wherein the training obtains probabilities of the events being misclassified.
